(19) United States
(12) Patent Application Publication
(10) Pub. No.: US 2026/0326766 A1
(43) Pub. Date: Oct. 22, 2026

(54) VEHICLE BRAKING MANAGEMENT SYSTEMS AND METHODS

(71) Applicant: CUMMINS INC., Columbus, IN (US)

(72) Inventors: J. Steven Kolhouse, Columbus, IN (US); Aaron William Beinborn, Greenwood, IN (US); Michael Stuglik, Greenwood, IN (US); Lisa A. Orth-Farrell, Columbus, IN (US); Kenneth M. Follen, Greenwood, IN (US); Ethan Charles Seifer, Hope, IN (US); Hoseinali Borhan, Bloomington, IN (US)

(21) Appl. No.: 19/108,942

(22) PCT Filed: Aug. 16, 2023
(86) PCT No.: PCT/US2023/072296

§ 371 Date: Mar. 5, 2025

Related U.S. Application Data
(60) Provisional application No. 63/374,792, filed on Sep. 7, 2022.

(51) Int. Cl. B60W 30/18; B60L 7/22; B60L 7/26; B60W 10/11; B60W 10/184; B60W 10/198

(52) U.S. Cl. CPC B60W 30/18127; B60L 7/22; B60L 7/26; B60W 10/11; B60W 10/184; B60W 10/198; B60W 30/18072; B60W 30/18136; B60W 2510/10; B60W 2510/18; B60W 2510/244; B60W 2530/20; B60W 2540/12; B60W 2552/15; B60W 2552/35; B60W 2555/20; B60W 2556/65; B60W 2710/1005; B60W 2710/18; B60W 2754/30

(57) ABSTRACT

Systems and methods are disclosed for managing the braking of a vehicle having a plurality of braking systems. A deceleration request is allocated among the plurality of braking systems based on the braking capability and priority weighting for usage of each of the plurality of braking systems.

### CROSS-REFERENCE TO RELATED APPLICATION

The present application claims priority to, and the benefit of the filing date of, U.S. Provisional Application Ser. No. 63/374,792 filed on Sep. 7, 2022, which is incorporated herein by reference in its entirety.

### BACKGROUND

Vehicles may include multiple driveline braking options, such as service (friction) braking, engine (compression) braking, regenerative braking, resistive braking, and aerodynamic braking. The ability to manage these various braking systems in order to provide the desired operational outcomes, such as achieving deceleration efficiently or managing faults conditions of the vehicle, is increasingly more important.

### SUMMARY

The present application discloses systems and methods for controlling braking in response to a deceleration request for a vehicle that include multiple braking systems. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example vehicle including a powertrain and a braking management system.

FIG. 2 is a schematic view of an embodiment of a braking management system of the vehicle of FIG. 1.

FIG. 3 is a schematic flow diagram of one embodiment procedure for managing braking of the vehicle of FIG. 1 with the braking management system of FIG. 2.

FIG. 4 is a schematic flow diagram of another embodiment procedure for managing braking of the vehicle of FIG. 1 with the braking management system of FIG. 2.

FIG. 5 is a schematic flow diagram of another embodiment procedure for managing braking of the vehicle of FIG. 1 with the braking management system of FIG. 2.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

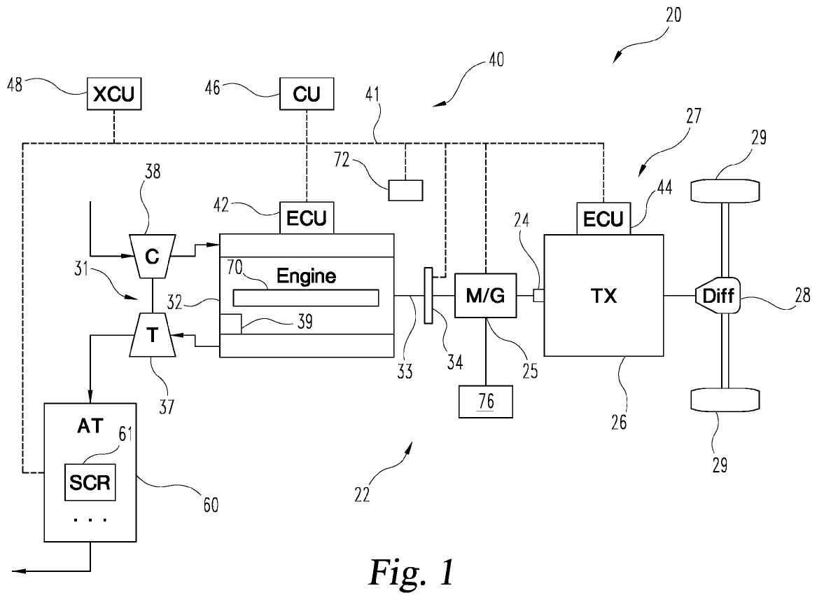

With reference to FIG. 1, there is illustrated an example vehicle 20. In the illustrated embodiment, vehicle 20 includes a powertrain 22. Powertrain 22 may be any suitable powertrain for a vehicle 20 that propels vehicle 20. Powertrain 22 may include any suitable prime mover or prime mover combinations, including one or more of an internal combustion engine, an electric motor, a fuel cell, and/or an energy storage device.

In the illustrated embodiment, powertrain 22 is shown with an internal combustion engine 32, an output shaft 33, a clutch 34, a motor/generator 25, and a drivetrain 27. Drivetrain 27 may include a transmission 26, a differential 28, and ground engaging wheels 29. In the illustrated embodiment, vehicle 20 is propelled along a road or route by ground engaging wheels 29, which are configured and provided as rear wheels. In other embodiments, front-wheel drive, four-wheel drive, and all-wheel drive approaches are contemplated. In various embodiments, vehicle 20 may be configured and provided as an on-road bus, delivery truck, a service truck, passenger truck, passenger car, or the like. In other aspects, vehicle 20 may be configured and provided as a different type of vehicle, including other types of on-road or off-road vehicles.

In the illustrated embodiment, the powertrain 22 includes internal combustion engine 32 operatively coupled with and configured to provide torque to output shaft 33. In some embodiments, output shaft 33 may be configured and provided as a flywheel and/or a crankshaft. A first side of clutch 34 is operatively coupled with and configured to provide torque to (or receive torque from) output shaft 33 and, in turn, engine 32. A second side of clutch 34 is operatively coupled with and configured to provide torque to (or receive torque from) motor/generator 25 and, in turn, an input shaft 24 of the transmission 26 and, in turn, to other components of the powertrain 22 which may be coupled therewith.

FIG. 1 illustrates just one type of clutch arrangement between powertrain components, however any type clutch or multiple clutch arrangement is contemplated, and the hybrid powertrain components can be arranged in parallel, series, or series-parallel. In other embodiments of vehicle 20, motor/generator 25, and/or clutch 34 are not provided or provided in a different configuration or arrangement, such as in non-hybrid powertrains that are propelled by engine 32 alone, an electric motor alone such as in a battery powered electric vehicle, a range extended electric vehicle, or a fuel cell powered vehicle.

When provided, clutch 34 is electronically controllable between a closed state and an open state. In the closed state, torque applied to the first side of clutch 34 is transferred to the second side of positive clutch 34 and vice-versa. In the open state, torque is not transferred between the first side and the second side of clutch 34, for example, due to a gap or separation between clutch components. While one example of clutch 34 is shown and described, clutch 34 may be any suitable type of mechanism for connecting and disconnecting engine 32 with motor/generator 25 and/or transmission 26, including friction clutches, positive clutches, wet clutches, dry clutches, and the like. In addition, more than one clutch may be provided depending on the arrangement between components of powertrain 22.

Motor/generator 25 is configured and provided in the form of a traction motor, which is separate and distinct from an optional starter motor 39. Motor/generator 25 can receive energy from an energy storage device 76, such as a battery, and is operable as a motor to output torque to input shaft 24 of transmission 26 to propel the vehicle 20. Such operation may occur with positive clutch 34 being open such that only motor/generator 25 is used to propel the vehicle. Such operation may also occur with positive clutch 34 being closed such that motor/generator 25 propels the vehicle 20 in combination with engine 32, or with engine 32 propelling vehicle 20 through motor/generator 25 while generating electrical energy with motor/generator 25. Motor/generator 25 is further operable as a generator to receive torque from input shaft 24 of transmission 26, for example, during regenerative braking operation to recharge energy storage device 76. Motor/generator 25 is further operable as a motor to drive engine 32 via positive clutch 34, for example, during engine starting operations.

Other embodiments contemplate other forms and/or locations for motor/generator 25. Motor/generator 25 could be at any location in the powertrain 22 and/or drivetrain 27, such as the engine crankshaft, engine flywheel, transmission 26, an e-axle with a central motor/generator, an e-axle with two motor-generators, or motor/generators mounted on individual wheels.

Transmission 26 may be configured and provided in a number of forms. In some forms, transmission 26 may be configured and provided as a manual transmission including a gearbox and an operator-actuated internal clutch. In some forms, transmission 26 may be configured and provided as an automated manual transmission including a gearbox and an internal clutch that may be automatically actuated or actuated in response to operator input. In some forms, transmission 26 may be configured and provided as an automatic transmission including a planetary gear set. In some forms, transmission 26 may be configured and provided as continuously variable transmission.

In the illustrated embodiment, engine 32 is configured as a turbocharged engine including an engine braking system 70. Engine braking system 70 may be provided in any suitable form that is are configured and operable to reduce cylinder pressure during a compression stroke of engine 32 relative to the cylinder pressure that would otherwise result from the compression stroke. In some forms, engine braking system 70 may be configured and provided to include cylinder deactivation (CDA) operation during which the intake valves and/or exhaust valves of one or more of the engine cylinders remains closed.

In some forms, engine braking system 70 may be configured and provided as a compression release braking system. In some such forms, a hydraulic or electric actuator may be provided in a valve train between a valve of engine 32 and a valve cam of engine 32 and may be electronically controlled to vary the response of the valve to the valve cam. For example, such an actuator may be provided to selectably maintain an exhaust valve and/or intake valve open and/or closed during at least a part of the piston stroke of the engine 32. In certain embodiments, the engine braking system 70 includes a braking disable switch (not shown). The braking disable switch can be manually controlled by the operator, and/or automatically controlled by the electronic control system based on vehicle location data. The braking disable switch indicates that engine braking is not to be utilized, such in cities or other areas where compression braking is not allowed by regulation.

Powertrain 22 may be provided with a turbocharger 31 including a turbine 37 and a compressor 38. Turbine 37 extracts energy from the exhaust gas from engine 32 to drive compressor 38 to compress charge air flow to engine 32. Turbine 37 can include a controllable inlet or wastegate that can be controlled as a mechanical braking device to decelerate vehicle 20. For example, turbine 37 may include a variable geometry turbocharger (VGT). Certain VGT devices can be adjusted to produce back pressure on the engine 32 and provide a braking effect (or exhaust brake) that, in moving toward a closed position, partially blocks an exhaust stream and applies back pressure on the engine resulting in a negative crankshaft torque amount. Still other exemplary mechanical braking devices include a hydraulic retarder, an exhaust brake, or an exhaust throttle. The hydraulic retarder, where present, is typically incorporated with the transmission 26. The exhaust throttle can be any valve in the exhaust system that provides a braking effect. The mechanical braking devices herein may be any braking device on vehicle 20 that is not the conventional friction/service brakes of the vehicle, the motor/generator 25, the engine braking system 70, the aerodynamic braking system, and/or the resistive braking system.

The vehicle 20 further includes a deceleration request device 72 that provides a deceleration or braking request. An exemplary deceleration request device 72 includes a brake pedal and brake pedal position sensor that receives an input from the brake pedal when actuated by the operator. Other deceleration request devices 72 include, for example, an adaptive cruise control system, a predictive cruise control system, an automated driving system, an advanced driver assistance system, a dynamic powertrain controller that automatically control powertrain output in response to look ahead data and target vehicle speeds along a route, an autonomous vehicle controller, an anti-lock braking (ABS) system, a power take-off (PTO) device, an electronic vehicle stability control system, a radar or LiDAR based automated braking system, and/or a network or datalink parameter communicating a deceleration request. However, any deceleration request device 72 operable to provide a deceleration or brake request, or a value that can be correlated to a present deceleration or brake request, is contemplated herein.

In the illustrated embodiment, vehicle 20 may include an exhaust aftertreatment system 60 provided downstream of engine 32 that received the exhaust flow and treats constituents in the exhaust flow for emissions reduction purposes. The exhaust aftertreatment system 60 may include a catalyst, such as selective catalyst reduction (SCR) catalyst 61. Other embodiments contemplate any suitable device or devices for exhaust aftertreatment, or the omission of exhaust aftertreatment when none is required.

The vehicle 20 includes an electronic control system (ECS) 40 that includes a plurality of control components and structures. ECS 40 may include one or more programmable microprocessors or microcontrollers of a solid-state, integrated circuit type that are provided in one or more constituent control units of ECS 40. It is also contemplated that ECS 40 may include other types of integrated circuits and/or discrete circuit control units. In the illustrated embodiment, ECS 40 includes an engine control unit (ECU) 42, a transmission control unit (TCU) 44, and a braking management control unit (BCU) 46. ECS 40 may include one or more additional control units (XCU) 48 that can be separate controllers or integrated fully or in part in one of the control units 42, 44, 46.

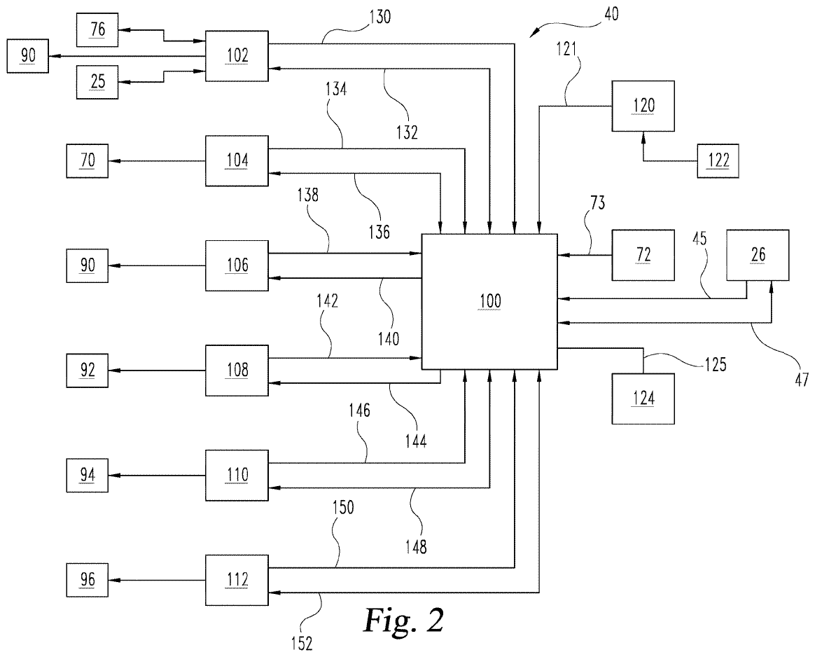

As discussed further below and with further reference to FIG. 2 and the braking management system illustrated therein, the one or more XCUs 48 can include one or more brake controllers associated with various braking systems of vehicle 20. In the illustrated embodiment, the braking controllers include a regeneration brake controller 102, an engine brake controller 104, a service brake controller 106, a resistive brake controller 108, an aerodynamic brake controller 110, and a mechanical brake controller 112. The XCU 48 can also be, for example, a controller or controllers for adaptive cruise control, predictive cruise control, automated vehicle control, advanced driver assistance control, stability and/or traction control, dynamic powertrain control, tire connectivity control, and/or vehicle speed control based on look ahead data and route conditions, and the like. ECU 42, TCU 44, BCU 46, and XCU 48 are operatively coupled with and configured for communication over a network 41 which may be configured as a controller area network (CAN) or another type of network providing communication capabilities. ECS 40 is also operatively coupled with various components and systems of the vehicle 20 via network 41 or one or more additional or alternative networks.

ECS 40 can be implemented in a number of configurations that combine or distribute control components, functions, or processes across one or more control units in various manners. ECS 40 executes operating logic, such as brake management logic 100 that defines various control, management, and/or regulation functions. This operating logic may be in the form of dedicated hardware, such as a hardwired state machine, analog calculating machine, programming instructions, and/or a different form as would occur to those skilled in the art. ECS 40 may be provided as a single component or a collection of operatively coupled components; and may be comprised of digital circuitry, analog circuitry, or a hybrid combination of both of these types. When of a multi-component form, ECS 40 may have one or more components remotely located relative to the others in a distributed arrangement. ECS 40 can include multiple processing units arranged to operate independently, in a pipeline processing arrangement, in a parallel processing arrangement, or the like. It shall be further appreciated that ECS 40 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

Certain operations described herein include determining one or more parameters. Determining, as utilized herein, includes calculating values and/or receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art, and/or by receiving a value by which the determined parameter can be calculated, and/or by referencing a default value that is determined to be the parameter value.

In certain embodiments, the ECS 40 includes one or more control units 42, 44, 46, 48 structured to functionally execute one or more operations to control braking/deceleration of vehicle 20. The ECS 40 includes brake management logic 100 that resides on one or more the control units 42, 44, 46, 48 that receives a deceleration request 73 from deceleration request device 72, determines a braking capability for each of the braking systems, and allocates the deceleration request among the various braking systems of vehicle 20 to satisfy the deceleration request.

Brake management logic 100 may also receive operating parameter inputs from, for example, a tire connectivity controller 120, transmission 25 and/or TCU 44, and/or route data 124. Tire connectivity controller 120 can be connected to one or more tire sensors 122 that provide inputs 121 to brake management logic 100 regarding tire conditions such as usage, pressure, wear, grip/connectivity, and other tire data during operation of vehicle 20. Route data 124 can include inputs 125 to brake management logic 100 regarding, for example, weather, road conditions, look ahead route data, vehicle-to-vehicle communications, vehicle-to-infrastructure communications, vehicle-to-facility communications, platoon data, fleet data, etc.

Vehicle 20 includes one or more braking systems, as shown in FIG. 2. The braking systems may include engine braking system 70, service braking system 90, resistive braking system 92, aerodynamic braking system 94, mechanical braking system 96, and/or regeneration braking system 98. In addition, transmission 26 may contribute to deceleration of vehicle 20.

Regeneration braking system 98 is actuated under control of regeneration brake controller 102. Regeneration brake controller 102 may also control energy storage device 76 for receiving energy for charging and for discharging energy. Regeneration brake controller 102 may also control motor generator 25 to propel vehicle 20, charge a battery or other energy storage device 76, or other functions.

In addition, engine braking system 70 is actuated under control of engine brake controller 104. Service braking system 90 is actuated under control of service brake controller 106. Resistive braking system 92 is actuated under control of resistive brake controller 108. Aerodynamic braking system 94 is actuated under control of aerodynamic brake controller 110. Mechanical braking system is 96 includes one or more devices, such as an exhaust throttle, an exhaust brake, a turbocharger, and/or a hydraulic retarder, that are actuated under control of mechanical brake controller 112.

In response to a deceleration or brake request 73, brake management logic 100 receives one or more inputs regarding the braking capability of each of the braking systems 70, 90, 92, 94, 96, 98 and outputs an allocation of the deceleration request to each of the braking systems 70, 90, 92, 94, 96, 98. For example, regeneration brake controller 102 provides a regeneration braking capability 130 for regeneration braking system 98. Regeneration braking capability 130 can be determined by various operating parameters associated with vehicle 20 such as, for example, availability and capacity of regeneration braking based on motor/generator type, motor speed, battery state, battery state-of-charge, power electronics capability, motor/generator temperature, battery temperature, cooling capacity, and response time.

Engine brake controller 104 provides an engine braking capability 134 for engine braking system 70. Engine braking capability 134 can be determined by various operating parameters associated with vehicle 20 such as, for example, availability and capacity of engine cylinder(s) for engine braking and response time, engine speed, compression ratio, boost pressure, overhead capabilities, exhaust backpressure, road grade, noise ordinances, intake air density/temperature, etc. Service brake controller 106 provides a service braking capability 138 for service braking system 90. Service braking capability 138 can be determined by various operating parameters associated with vehicle 20 such as, for example, availability of the service brake, capacity of the service brakes due to pad/shoe wear and tire conditions, brake pad type and size, ABS settings, tire size, tire compound, tire pressure, road conditions (wet, icy, hot, etc.), road type, ambient conditions, and response time.

Resistive brake controller 108 provides a resistive braking capability 142 for resistive braking system 92. Resistive braking capability 142 can be determined by various operating parameters associated with vehicle 20 such as, for example, availability and capacity of resistor bank(s) for braking, types of resistors, quantity of resistors, individual resistor capacity, system architecture, resistor temperatures and temperature limits, cooling capacity, and response time. Aerodynamic brake controller 110 provides an aerodynamic braking capability 146 for aerodynamic braking system 94. Aerodynamic braking capability 146 can be determined by various operating parameters associated with vehicle 20 such as, for example, availability of aero braking features, capacity of aero braking features based on vehicle speed, following distance, vehicle type, vehicle weight, wind velocity and direction, and response time. Mechanical brake controller 112 provides a mechanical braking capability 150 for mechanical braking system 96. Mechanical braking capability 150 can be determined by various operating parameters associated with vehicle 20 such as, for example, the availability, number, and capacity of mechanical devices such as such as an exhaust throttle, an exhaust brake, a turbocharger, and a hydraulic retarder, for braking.

Other operating parameters that may be considered by brake management logic 100 in allocating the braking request among braking systems 70, 90, 92, 94, 96, 98 include environmental factors. Environmental factors include, for example, vehicle speed, vehicle gross weight, road grade, vehicle location, and destination. Other environmental factors include lead vehicle speed and following distance, and trailing vehicle speed and following distance. Brake management logic 100 may also consider remaining useful life of system components, including whether to preserve remaining useful life or to prioritize usage due to an impending change, retirement, or sale.

Braking management logic 100 may receive also operating parameter inputs broadcast from the other controllers and components of vehicle 20, such as ECU 42, TCU 44, tire connectivity controller 120, route data 124, etc. Based on the various operating parameter inputs, braking management logic 100 analyzes system requirements, such as deceleration request 73, safety constraints, and system hardware constraints, to determine how the deceleration request 73 will be satisfied by vehicle 20. Brake management logic 100 can consider the availability, capacity, response times, government regulations such as noise constraints, road type and conditions, and braking costs in terms of fuel efficiency, component durability, component cost, and service time/costs, for each of the systems capable of providing braking. Based on these considerations, brake management logic 100 allocates the deceleration request among the various braking systems 70, 90, 92, 94, 96, 98 and/or transmission 26, and can actuate or command the braking system(s) 70, 90, 92, 94, 96, 98 and/or transmission 26 to meet deceleration request 73 at the lowest cost without violating operating constraints. Brake management logic 100 can also broadcast the braking capabilities of the various braking systems 70, 90, 92, 94, 96, 98 and/or transmission 26 to other controllers of ECS 40 and/or to controllers outside ECS 40.

In an embodiment, brake control logic 100 prioritizes and/or controls the desired amount of braking or deceleration to be provided by the various braking systems 70, 90, 92, 94, 96, 98 and/or transmission 26 concurrently to achieve the deceleration request 73. For example, brake management logic 100 provides a regeneration braking allocation 132 to regeneration brake controller 102 to command actuation of regeneration braking system 98. Brake management logic 100 provides an engine braking allocation 136 to engine brake controller 104 to command actuation of engine braking system 70. Brake management logic 100 provides a service braking allocation 140 to service brake controller 106 to command actuation of service braking system 90. Brake management logic 100 provides a resistive braking allocation 144 to resistive brake controller 108 to command actuation of resistive braking system 92. Brake management logic 100 provides an aerodynamic braking allocation 148 to aerodynamic brake controller 110 to command actuation of aerodynamic braking system 94. Brake management logic 100 provides a mechanical braking allocation 152 to mechanical brake controller 112 to command actuation of mechanical braking system 96.

Brake management logic 100 can also receive transmission data 45 from TCU 44 and provide transmission commands 46 to modify or control shifts and/or shift schedules to assist in satisfying the deceleration request. Brake management logic 100 can determine a priority or weighting to be applied for usage of each of the braking systems 70, 90, 92, 94, 96, 98 and/or transmission 26. For example, usage of service braking system 90 can be minimized or de-prioritized when other braking system capabilities or coasting are available to minimize wear and service of the friction brake components. In another example, regeneration braking system 98 can be de-prioritized or disabled in response to a state-of-charge of battery 76 being full. In another embodiment, brake management logic 100 prioritizes coasting of vehicle 20 when possible by decoupling the powertrain 22 from the ground-engaging wheels 29.

In an embodiment, brake management logic 100 prioritizes the use of regeneration braking system 98 based on state-of-charge limits for battery 76 to minimize the total cost of operation and/or avoid or reduce actuation of service braking system 90. In an embodiment, brake management logic 100 prioritizes the use of engine braking system 70 to minimize or equalize mechanical wear with service braking system 90. In an embodiment brake management logic 100 selects the braking mode or priority in use of the braking systems 70, 90, 92, 94, 96, 98 and/or transmission 26 based on the OEM, Fleet, or Operator's pre-determined selection or preference.

Brake management logic 100 can also receive inputs of the operating parameters of the other systems of vehicle 20 and determine the amount of braking or deceleration of vehicle 20 those systems can provide and/or how current operating conditions impact braking capabilities of the braking systems 70, 90, 92, 94, 96, 98. These other systems, which can assist in deceleration, and which may also produce a deceleration request, include, for example, adaptive cruise control systems, predictive cruise control systems, automated driving systems, advanced driver assistance systems, dynamic powertrain controllers, autonomous vehicle controllers, ABS systems, PTO devices, electronic vehicle stability control systems, and/or radar or LiDAR based automated braking systems. For example, brake management logic 100 can receive data regarding tire connectivity from tire connectivity controller 120 and determine impacts on braking and deceleration due to, for example, wet or slick road conditions or tire wear. These impacts on deceleration can be communicated to braking systems 70, 90, 92, 94, 96, 98 and these other systems to inform braking capability limits, and allow appropriate modifications to following and stopping distances such as might be employed in autonomous vehicle or driver assisted control.

Braking management logic 100 may also determine if a deceleration request 73 currently exceeds a braking capability based on a current braking priority and allocations of the deceleration request among the braking systems 70, 90, 92, 94, 96, 98, and recalculate or re-weight the braking priority in order to satisfy the deceleration request 73. Braking management logic 100 may also determine whether current braking allocations among the braking systems 70, 90, 92, 94, 96, 98 are occurring at a rate or amount sufficient to satisfy the deceleration request 73, and re-prioritize or re-weight braking system allocations if a different rate of deceleration is desired.

Brake management logic 100 may also receive other inputs not listed above and take such inputs in consideration in determining the allocation of the deceleration request among the braking systems 70, 90, 92, 94, 96, 98. These other inputs may include, for example, air handling considerations such as for an intake throttle or variable geometry turbine; charge cycles of a battery of energy storage system 76; noise regulations at the vehicle location; cylinder deactivation conditions; fuel cell temperatures; upcoming service events; service brake life; response times and braking costs of the various braking systems; service time and/or service cost of the braking systems; durability and/or cost of the components of the braking systems; road types and associated tire grip; current vehicle weight; engine temperature; aftertreatment temperature; safety constraints; and system or hardware constraints.

Brake management logic 100 may also receive inputs originating from outside of vehicle 20 such as from a fleet, platoon, and/or autonomous vehicle management system or owner. These inputs to the brake management logic 100 in the associated vehicles 20 can be used to influence or affect the allocation of the deceleration request across the fleet, platoon, or system of vehicles. The preferences for the deceleration request allocation can be made among the braking systems 70, 90, 92, 94, 96, 98 and/or other vehicle controllers associated with, for example, adaptive cruise control systems, predictive cruise control systems, automated or autonomous driving systems, advanced driver assistance systems, dynamic powertrain control systems, and/or a radar or LiDAR based automated braking systems. In an embodiment, fleet, platoon or system preferences for braking allocation take priority, but preferences or priorities can change on a vehicle-by-vehicle basis based on fault detection of a braking system or driver input in the associated vehicle 20.

Brake management logic 100 may also be configured to announce or output a braking capability for one or more braking systems 70, 90, 92, 94, 96, 98 to a controller of another braking system 70, 90, 92, 94, 96, 98, or to an integrated system-wide controller of vehicle 20, in order to determine the contribution available from the braking system(s) 70, 90, 92, 94, 96, 98 that can be used to satisfy the deceleration request. Brake management logic 100 may also be configured to announce or output a braking capability for one or more braking systems 70, 90, 92, 94, 96, 98 to nearby vehicles in a fleet, platoon, and/or autonomous vehicle management system to coordinate deceleration among the various vehicles.

Brake management logic 100 may also be employed for fault detection and/or potential fault management of one or more components of vehicle 20. For example, brake management logic 100 can detect a fault or detect a potential fault in engine braking system 70, service braking system 90, resistive braking system 92, aerodynamic braking system 94, mechanical braking system 96, regeneration braking system 98, energy storage device 76, engine 32, motor/generator 25, transmission 26, clutch 34, wheels 29, etc. In an embodiment, brake management logic 100 avoids or reduces usage of the affected braking system(s) 70, 90, 92, 94, 96, 98 in response to the fault or potential fault. In an embodiment, brake management logic 100 takes pre-emptive mitigation measures to manage a condition before a fault condition occurs and determines braking priority to avoid or reduce the potential occurrence of a fault event among the braking system(s) 70, 90, 92, 94, 96, 98.

In an embodiment, brake management logic 100 communicates the fault condition or potential fault condition to the driver, fleet, or system to repair or mitigate the fault or fault condition. Brake management logic 100 can change, re-order, re-weight, or disable the affected braking system(s) 70, 90, 92, 94, 96, 98 to prevent or reduce their usage, or to delay the potential fault condition. Brake management logic 100 can change, modify, or adopt a different transmission shift strategy in response to the fault condition or potential fault condition. Brake management logic 100 can continuously monitor and adapt the allocation of deceleration requests among the braking system(s) 70, 90, 92, 94, 96, 98 based on a current state of the fault condition or potential fault condition. In mission critical or safety situations, brake management logic 100 may override a disablement or reduction in priority of an affected braking system(s) 70, 90, 92, 94, 96, 98.

Any suitable sensor or combination of sensors can be used to detect or sense a fault condition or potential fault condition with braking systems 70, 90, 92, 94, 96, 98 or other component of vehicle 20. Possible engine and powertrain sensors include sensors for engine speed, coolant temperature, oil temperature, exhaust temperature, battery state-of-charge, motor generator speed, cylinder pressure, etc. Possible vehicle/ADAS sensors include, for example, sensors for road speed, tire pressure, tire temperature, road angularity, ambient temperature, service brake status, etc. Possible transmission sensors include, for example, sensors for gear selection, transmission fluid temperature, road grade, pressure, level, etc. Possible battery sensors include, for example, sensors for battery temperature, smoke detection, gas detection, battery voltage, state-of-charge, battery health, battery discharge (current flow), etc. The vehicle camera system can include sensors capable of interpreting visual indicators such as signs, lane markings, lane change signs/barrels, look ahead objects, adjacent vehicles at front, rear and lateral sides, on-coming vehicles etc. Possible tire sensors include sensors for tire pressure, tire temperature, and tread wear. Other tire input data may include tire size, compound, and age. As discussed above, vehicle 20 can be equipped with either radar or LiDAR detection systems, and can be equipped to receive look-ahead route data, road type, road grade, traffic, construction, and/or weather data.

In an embodiment, brake management logic 100 detects a fault condition associated with engine braking system 70 in response to one or more inputs of engine position, engine speed, intake manifold pressure, exhaust manifold pressure, exhaust gas temperature, turbine inlet temperature, charge flow estimate, and/or accelerometer. In response to the fault or notification of fault, engine braking system 70 can be disabled or reduced in availability, on a cylinder-by-cylinder basis or the entire system. The following distance from a vehicle-in-front is increased for those systems that utilize such requirements, such as adaptive cruise control systems, advanced driver assistance system, and autonomous driving systems. In addition, these systems are informed that engine braking is not available or less capable so they will utilize other braking systems, such as regeneration braking system 98 or service braking system 90.

Brake management logic 100 can then re-prioritize engine braking relative to regeneration braking and service braking such that engine braking is not issued, or is used less frequently. Predictive cruise control and/or dynamic powertrain control features in which vehicle speed control is controlled automatically versus a target speed in response to look ahead conditions can be limited or disabled. The ability to coast in neutral can also be disabled, and the transmission shift schedule or gear selection is modified to aid engine retard via vacuum braking, such as in situation requiring maximum braking like going down a hill.

In an embodiment, brake management logic 100 detects a fault condition associated with service braking system 90 in response to one or more inputs of hydraulic brake pressure, tire temperature, operator detection (audible noise, brake pedal is soft, brake pedal not effective), actual versus expected braking performance, vehicle pull left or right, under-brake operation, etc. In response to detection of a fault condition, brake management logic 100 can disable service braking function and/or availability and inform other controller(s) of the vehicle 20 the fault and limited capability/availability. The following distance from a vehicle-in-front is increased for those systems that utilize such requirements, such as adaptive cruise control, advanced driver assistance system, and autonomous driving systems. In addition, these systems are informed that service braking is not available or less capable so they will utilize regeneration braking system 98 or engine braking system 70.

For example, brake control logic 100 can re-prioritize engine braking and/or regeneration braking over service braking in response to a service braking fault condition. In an embodiment, regeneration braking usage is maximized and control limits are extended as appropriate. The motor/generator 25 can be cooled proactively in anticipation of higher loading, and derate filters are removed to allow for maximum battery charge. Predictive cruise control and/or dynamic powertrain control features in which vehicle speed is controlled automatically versus a target speed in response to look ahead conditions are limited or disabled.

For a non-hybrid powertrain 22, the transmission 26 can be downshifted to increase engine braking capability. For a hybrid powertrain 22, the transmission 26 can be downshifted, or a continuously variable transmission adjusted, to increase regeneration and/or engine braking capabilities. For an electric vehicle powertrain 22, transmission 26 can be downshifted, or continuously variable transmission adjusted, to increase regeneration braking capability.

In addition, any available emergency brake system of vehicle 20 is utilized. In an emergency scenario, system air pressure can be released by the operator, such as via a dashboard switch, to engage the service brakes in a default failure position. The proportional valves of service braking system 90 can also be adjusted to minimize and/or bypass the problem service brake or brakes.

In an embodiment, brake management logic 100 detects a potential fault condition associated with service braking system 90 and manages the potential fault condition to minimize its impact or delay the indicated fault condition. The potential fault condition can be detected by, for example, estimating rolling resistance of vehicle 20, monitoring for steering abnormalities by comparing actual to predicted steering angle, using cameras to detect smoke or other visible conditions, temperature measurement of the tire and/or rim, audio detection of a blown tire, noise, vibration, and/or harshness detection of a blown tire via accelerometer, comparing actual versus commanded vehicle deceleration and/or vehicle acceleration.

In response to detecting a potential fault condition with service braking system 90, brake control logic 100 can cause vehicle 20 to slow down, pull over, and/or notify fleet or emergency services, and activate vehicle hazard lights or other warning system. Brake control logic 100 may also make a gear adjustment in transmission 26 to maximize engine braking and/or regeneration braking torque to the wheels to slow the vehicle in preparation for a roadway exit. State-of-charge and/or charging rate threshold limited can be overridden if necessary to enable maximum braking in support for vehicle safety. Any adaptive cruise control, dynamic powertrain control, and other features based on look ahead data to control the vehicle speed are deactivated. In addition, the impacted service brake or brakes can be deactivated, and the associated braking contribution reallocated to other braking systems and/or other service brakes. Other mitigation techniques in de-rating or limiting a power output of powertrain 22 and/or limit the speed of vehicle 20. If possible, the drive axle can be re-routed or converted into a non-drive or neutral coast axle.

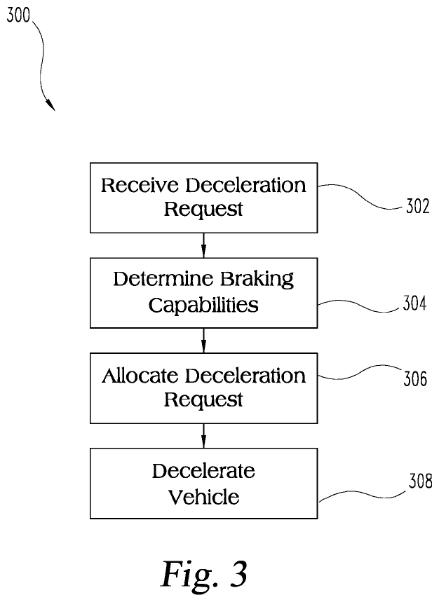

Referring to FIG. 3, an embodiment of a method 300 for braking vehicle 20 including a plurality of braking systems 70, 90, 92, 94, 96, 98 is disclosed. Method 300 includes an operation 302 for receiving a deceleration request for decelerating the vehicle 20. Method 300 includes an operation 304 for determining a braking capability for each of the plurality of braking systems 70, 90, 92, 94, 96, 98 upon receiving the deceleration request.

Method 300 includes an operation 306 for allocating the deceleration request among one or more of the plurality of braking systems 70, 90, 92, 94, 96, 98 based on the braking capability of each of the plurality of braking systems 70, 90, 92, 94, 96, 98. Method 300 includes an operation 308 for decelerating the vehicle 20 with one more of the plurality of braking systems 70, 90, 92, 94, 96, 98 in response to the allocation of the deceleration request among the plurality of braking systems 70, 90, 92, 94, 96, 98.

In an embodiment, method 300 includes determining a braking capability of a transmission 26 of vehicle 20, allocating at least part of the deceleration request to the transmission 26 based on the braking capability of transmission 26, and altering a state of the transmission 26 in response to the allocated part of the deceleration request. Altering the state of the transmission 26 includes modifying a current gear of the transmission 26 and/or modifying a shift schedule of the transmission 26.

In an embodiment of method 300, at least two of the plurality of braking systems 70, 90, 92, 94, 96, 98 simultaneously decelerating the vehicle 20 in response to the allocation of the deceleration request among the plurality of braking systems 70, 90, 92, 94, 96, 98. In an embodiment, the deceleration request is allocated among at least two of the plurality of braking systems 70, 90, 92, 94, 96, 98 and each of the at least two braking systems 70, 90, 92, 94, 96, 98 are applied concurrently to satisfy the deceleration request.

In an embodiment, method 300 includes communicating the braking capabilities of each of the plurality of braking systems 70, 90, 92, 94, 96, 98 to one or more of an adaptive cruise control system, a predictive cruise control system, an autonomous driving system, and/or an advanced driver assistance system. In an embodiment, method 300 includes prioritizing usage of one or more of the plurality of braking systems 70, 90, 92, 94, 96, 98 over one or more other of the plurality of braking systems 70, 90, 92, 94, 96, 98.

In an embodiment, method 300 includes evaluating one or more operating parameters associated with the vehicle 20 in order to determining the braking capability for each of the plurality of braking systems 70, 90, 92, 94, 96, 98 upon receiving the deceleration request. The one or more operating parameters can be provided by, for example, at least one of: an adaptive cruise control system, advanced driver assistance system, an automated driving system, a dynamic powertrain control system, an anti-lock brake system, a vehicle electronic stability control system, a road condition sensor, a road grade sensor, weather data, a look ahead route data system, a LiDAR detection system, a radar detection system, a tire sensor, a vehicle-to-vehicle communication system, a platoon communication system, a traffic control system, and a transportation infrastructure communication system.

In an embodiment, method 300 includes determining a deceleration capability associated with coasting the vehicle 20, and prioritizing coasting the vehicle 20 to meet the deceleration request before decelerating the vehicle 20 with the one or more braking systems 70, 90, 92, 94, 96, 98.

In an embodiment, method 300 includes detecting a fault associated with one of the plurality of braking systems 70, 90, 92, 94, 96, 98, and re-allocating the deceleration request among the other of the plurality of braking systems 70, 90, 92, 94, 96, 98. In an embodiment, method 300 includes detecting a fault associated with one of the plurality of braking systems 70, 90, 92, 94, 96, 98, and at least partially disabling the braking system 70, 90, 92, 94, 96, 98 for which the fault was detected.

In response to detecting the fault, method 300 may include one or more of altering a state of the transmission 26, increasing a following distance from a vehicle-in-front of the vehicle 20, re-prioritizing a usage priority among the plurality of braking systems 70, 90, 92, 94, 96, 98, identifying the fault as a thermal event associated with service braking system 90, and deactivating an impacted service brake of the service braking system 90 in response to the thermal event.

In an embodiment, method 300 includes determining a usage priority among the plurality of braking systems 70, 90, 92, 94, 96, 98 in response to the deceleration request and one or more operating parameters associated with the vehicle 20, and allocating the deceleration request among one or more of the plurality of braking systems 70, 90, 92, 94, 96, 98 based on the usage priority and braking capability of each of the plurality of braking systems 70, 90, 92, 94, 96, 98. In an embodiment of method 300, allocating the deceleration request among one or more of the plurality of braking systems 70, 90, 92, 94, 96, 98 includes assigning a pro rata share of the deceleration request to each of the plurality of braking systems 70, 90, 92, 94, 96, 98. The pro rate share of the deceleration request can vary between 0% and 100% such that 100% of the deceleration request is allocation among braking systems 70, 90, 92, 94, 96, 98 and/or transmission 26.

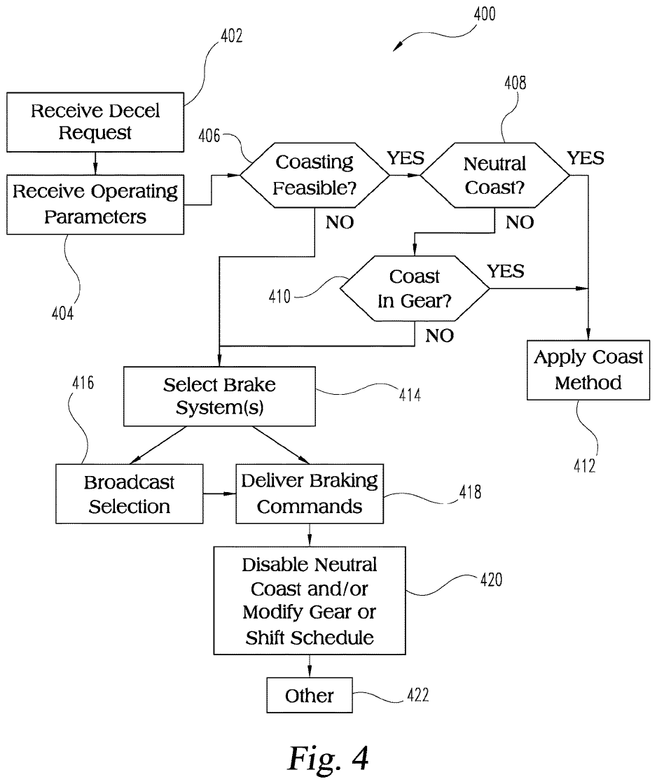

Referring to FIG. 4, an embodiment of a method 400 is shown for prioritizing transmission 26 and braking systems 70, 90, 92, 94, 96, 98 to decelerate vehicle 20 in response to a deceleration request 73. Method 400 includes an operation 402 to receive a deceleration request and an operation 404 to receive operating parameters associated with vehicle 20. Procedure 400 continues at conditional 406 to determine if coasting is feasible to meet the deceleration request. If conditional 406 is YES, method 400 continues at conditional 408 to determine if neutral coasting is feasible to meet the deceleration request and is available in view current operating requirements for vehicle 20. If conditional 408 is NO, method 400 continues at conditional 410 to determine if coasting in gear can meet the deceleration request and is available in view of current operating requirements for vehicle 20. If either conditional 408 or conditional 410 is YES, method 400 continues at operation 412 to apply the coasting method to satisfy the deceleration request.

If either conditional 406 or conditional 410 is NO, method 400 continues at operation 414 to select one or more of braking systems 70, 90, 92, 94, 96, 98 to meet the deceleration request. As discussed further herein, operation 414 can determine a priority of braking systems 70, 90, 92, 94, 96, 98 to be employed and which of the braking systems 70, 90, 92, 94, 96, 98 are available for meeting the deceleration request.

From operation 414, method 400 continues at operation 416 to broadcast the braking system selection and allocations of the deceleration request among the braking systems 70, 90, 92, 94, 96, 98. Method 400 continues at operation 418 to deliver braking commands to the controllers of braking systems 70, 90, 92, 94, 96, 98. Method 400 continues at operation 420 to disable neutral coasting, and/or to modify the transmission shift schedule/gear selection.

Method 400 may include, for example, various other additional operations 422. For example, additional operations 422 may include informing ECS 40 and/or the braking systems 70, 90, 92, 94, 96, 98 of faults or other malfunctions. Another example additional operation 422 can include increasing a following distance from a vehicle-in-front. Another example additional operation 422 can include informing an adaptive cruise control system, advanced driver assistance system, an automated driving system, a dynamic powertrain control system, an anti-lock brake system, a vehicle electronic stability control system, a road condition sensor, a road grade sensor, weather data, a look ahead route data system, a LiDAR detection system, a radar detection system, a tire sensor, a vehicle-to-vehicle communication system, a platoon communication system, a traffic control system, and a transportation infrastructure communication system of faults or other malfunctions and/or the allocation among braking systems 70, 90, 92, 94, 96, 98.

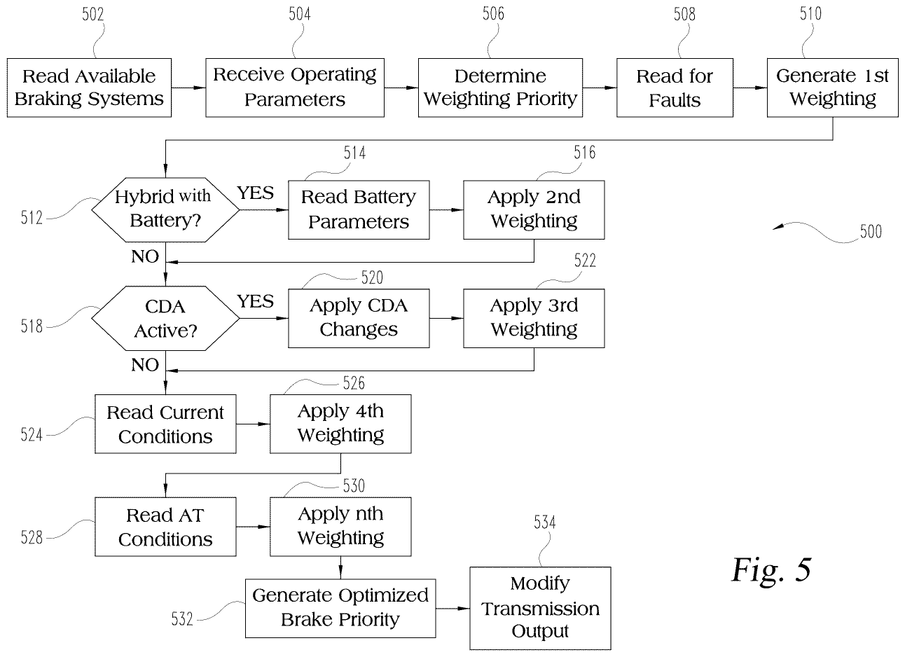

Referring to FIG. 5, another embodiment method 500 is shown for selecting, prioritizing and allocating the deceleration request among the braking systems 70, 90, 92, 94, 96, 98. In an embodiment, method 500 embodies operation 414 of method 400 discussed above.

Method 500 includes an operation 502 to read the available braking systems 70, 90, 92, 94, 96, 98 for the vehicle 20. Method 500 continues at operation 504 to receive operating parameter inputs from other data sources associated with vehicle 20 and apply any health considerations for the braking systems 70, 90, 92, 94, 96, 98 and/or components of vehicle 20.

Method 500 continues at operation 506 to determine an initial or first weighting priority among the braking systems 70, 90, 92, 94, 96, 98 to use in satisfying the deceleration request. Method 500 continues at operation 508 to read for any faults or potential faults among braking systems 70, 90, 92, 94, 96, 98 or other vehicle components. At operation 510, a first weighting is generated for the priority among braking systems 70, 90, 92, 94, 96, 98 based on the faults, potential faults, and wear/health of the braking systems and other vehicle components.

Method 500 continues after operation 510 to generate a second weighting. For example, at conditional 512 method 500 determines if the vehicle 20 includes a hybrid powertrain with a battery. If conditional 512 is YES, method 500 continues at operation 514 to read SOC, battery conditions, state of power, charge rate, discharge rate, etc. associated with the battery. Method 500 then continues at operation 516 to apply the second weighting to the allocation of the deceleration request among braking systems 70, 90, 92, 94, 96, 98 that optimizes the battery SOC.

If conditional 512 is NO, or after operation 516, method 500 continues to generate a third weighting. For example, at conditional 518 method 500 determines if CDA is active. If conditional 518 is YES, method 500 continues at operation 520 to apply changes to CDA, such as be disabling or changing the CDA operation. Method 500 continues at operation 522 to apply the third weighting to the allocation of the deceleration request among braking systems 70, 90, 92, 94, 96, 98 based on the CDA disablement or changes.

If conditional 518 is NO, or after operation 522, method 500 continues to generate a fourth weighting. For example, method 500 continues at operation 524 to read current conditions associated with the operation of vehicle 20, such as vehicle speed, mass, temperature conditions of the components of vehicle 20, etc. Method 500 continues at operation 526 to apply the fourth weighting to 522 to apply the fourth weighting to the allocation of the deceleration request among braking systems 70, 90, 92, 94, 96, 98 based on current conditions and/or vehicle health. The application of the fourth weighting in operation 526 may consider, for example engine temperature and/or transmission temperature to prioritize braking systems that warm or prevent damage to engine 32 or transmission 26, speed thresholds that dictate or favor selection of certain braking systems, or vehicle weight and speed conditions that dictate or favor selection of certain braking systems.

Method 500 can continue with multiple additional weightings. For example, in the illustrated embodiment method 500 continues with an nth weighting after operation 526. The nth weighting includes an operation 528 to determine aftertreatment temperatures and/or health of aftertreatment components. At operation 530, the nth weighting can be applied to determine priority to satisfy the deceleration request among braking systems 70, 90, 92, 94, 96, 98 based on aftertreatment temperature, age, health and/or emissions compliance requirements.

Method 500 continues at operation 532 to generate an optimized brake priority among the braking systems 70, 90, 92, 94, 96, 98 after consideration of the first through the nth weightings. Method 500 may also include an optional operation 534 to modify a transmission shift schedule or current gear selection in response to the deceleration request and the optimized brake priority among the braking systems 70, 90, 92, 94, 96, 98.

As is evident from the figures and text presented above, and claims that follow, a variety of aspects and embodiments according to the present application are contemplated. According to one aspect, a method for braking a vehicle that includes a plurality of braking systems includes receiving a deceleration request for decelerating the vehicle; determining a braking capability for each of the plurality of braking systems upon receiving the deceleration request; allocating the deceleration request among one or more of the plurality of braking systems based on the braking capability of each of the plurality of braking systems; and decelerating the vehicle with one more of the plurality of braking systems in response to the allocation of the deceleration request among the plurality of braking systems.

In an embodiment, the method includes determining a braking capability of a transmission of the vehicle; allocating at least part of the deceleration request to the transmission based on the braking capability of the transmission; and altering a state of the transmission in response to the allocated part of the deceleration request. In a further embodiment, altering the state of the transmission includes modifying a current gear of the transmission and/or modifying a shift schedule of the transmission.

In an embodiment, at least two of the plurality of braking systems simultaneously decelerate the vehicle in response to the allocation of the deceleration request among the plurality of braking systems.

In an embodiment, the deceleration request is allocated among at least two of the plurality of braking systems and each of the at least two braking systems are applied concurrently to satisfy the deceleration request.

In an embodiment, the method includes communicating the braking capabilities of each of the plurality of braking systems to one or more of an adaptive cruise control system, a predictive cruise control system, a dynamic powertrain controller, and an advanced driver assistance system.

In an embodiment, the method includes prioritizing usage of one or more of the plurality of braking systems over one or more other of the plurality of braking systems.

In an embodiment, the method includes evaluating one or more operating parameters associated with the vehicle in order to determining the braking capability for each of the plurality of braking systems upon receiving the deceleration request. In a further embodiment, the one or more operating parameters are provided by at least one of: an adaptive cruise control system, an advanced driver assistance system, an automated driving system, a dynamic powertrain control system, an anti-lock brake system, a vehicle electronic stability control system, a road condition sensor, a road grade sensor, weather data, a look ahead route data system, a LiDAR detection system, a radar detection system, a tire sensor, a vehicle-to-vehicle communication system, a platoon communication system, a traffic control system, and a transportation infrastructure communication system.

In an embodiment, the method includes determining a deceleration capability associated with coasting the vehicle; and prioritizing coasting the vehicle to meet the deceleration request before decelerating the vehicle with the one or more braking systems.

In an embodiment, the method includes detecting a fault associated with one of the plurality of braking systems; and re-allocating the deceleration request among the other of the plurality of braking systems in response to the fault.

In an embodiment, the method includes detecting a fault associated with one of the plurality of braking systems; and at least partially disabling the braking system for which the fault was detected.

In a further embodiment, the method includes altering a state of the transmission in response to detecting the fault. In a further embodiment, the method includes increasing a following distance from a vehicle-in-front of the vehicle in response to detecting the fault. In a further embodiment, the method includes re-prioritizing a usage priority among the plurality of braking systems in response to detecting the fault.

In a further embodiment, the fault is a thermal event associated with a service braking system. In yet a further embodiment, the method includes deactivating an impacted service brake of the service braking system in response to the thermal event.

In an embodiment, the method includes determining a usage priority among the plurality of braking systems in response to the deceleration request and one or more operating parameters associated with the vehicle; and allocating the deceleration request among one or more of the plurality of braking systems based on the usage priority and braking capability of each of the plurality of braking systems.

In an embodiment, allocating the deceleration request among one or more of the plurality of braking systems includes assigning a pro rata share of the deceleration request to each of the plurality of braking systems.

In a further embodiment, the plurality of braking systems includes a service braking system and at least one of a regeneration braking system and an engine braking system. In a further embodiment, the plurality of braking systems further includes at least one of a resistive braking system and an aerodynamic braking system.

In a further embodiment, the plurality of braking systems further includes a mechanical braking system, the mechanical braking system including one or more mechanical braking devices selected from: an exhaust throttle, an exhaust brake, a turbocharger, and a hydraulic retarder.

In an embodiment, the method includes determining a braking capability of a regeneration braking system of the vehicle, wherein the braking capability of the regeneration braking system is based on one or more of torque limits for a motor/generator of the vehicle, a battery state of charge, a battery state of health, and a battery state of power; and allocating at least part of the deceleration request to the regeneration braking transmission based on the braking capability of the regeneration braking system.

According to another aspect, a vehicle includes a powertrain coupled to a drive shaft, one or more grounding engaging wheels that are driven by the drive shaft, a deceleration request device configured to provide a deceleration request to decelerate the vehicle, a plurality of braking systems each configured to decelerate the vehicle, and at least one controller configured to receive the deceleration request and output one or more braking commands to the plurality of braking systems. The controller is configured to determine a braking capability for each of the plurality of braking systems associated with the deceleration request, allocate the deceleration request among one or more of the plurality of braking systems based on the braking capability of each of the plurality of braking systems, and decelerate the vehicle with the one more of the plurality of braking systems in response to the allocation of the deceleration request among the plurality of braking systems.

In an embodiment, the powertrain includes at least one of an internal combustion engine and an electric motor capable of rotating the drive shaft.

In an embodiment, the plurality of braking systems includes a service braking system and at least one of a regeneration braking system and an engine braking system. In a further embodiment, the plurality of braking systems further includes at least one of a resistive braking system and an aerodynamic braking system. In a further embodiment, the plurality of braking systems further includes a mechanical braking system, the mechanical braking system including one or more mechanical braking devices selected from: an exhaust throttle, an exhaust brake, a turbocharger, and a hydraulic retarder.

In an embodiment, the vehicle includes a transmission coupled to the drive shaft, and the controller is configured to determine a braking capability of the transmission of the vehicle, allocate at least part of the deceleration request to the transmission based on the braking capability of the transmission, and alter a state of the transmission in response to the allocated part of the deceleration request. In a further embodiment, the state of the transmission is altered by modifying a current gear of the transmission and/or modifying a shift schedule of the transmission.

In an embodiment, the deceleration request device comprises a brake pedal. In an embodiment, the controller is configured to prioritize usage of one or more of the plurality of braking systems over one or more other of the plurality of braking systems.

In an embodiment, the controller is configured to evaluate one or more operating parameters associated with the vehicle in order to determining the braking capability for each of the plurality of braking systems upon receiving the deceleration request. The one or more operating parameters are provided by at least one of: an adaptive cruise control system, advanced driver assistance system, an automated driving system, a dynamic powertrain control system, an anti-lock brake system, a vehicle electronic stability control system, a road condition sensor, a road grade sensor, weather data, a look ahead route data system, a LiDAR detection system, a radar detection system, a tire sensor, a vehicle-to-vehicle communication system, a platoon communication system, a traffic control system, and a transportation infrastructure communication system.

In an embodiment, the controller is configured to determine a deceleration capability associated with coasting the vehicle and prioritize coasting the vehicle to meet the deceleration request before decelerating the vehicle with the one or more braking systems.

In an embodiment, the controller is configured to detect a fault associated with one of the plurality of braking systems, and re-allocate the deceleration request among the other of the plurality of braking systems in response to the fault.

In an embodiment, the controller is configured to detect a fault associated with one of the plurality of braking systems, and at least partially disable the braking system for which the fault was detected.

In a further embodiment, the controller is configured to increase a following distance from a vehicle-in-front of the vehicle in response to detecting the fault. In a further embodiment, the controller is configured to re-prioritize a usage priority among the plurality of braking systems in response to detecting the fault. In a further embodiment, the fault is a thermal event associated with a service braking system.

In an embodiment, the controller is configured to determine a usage priority among the plurality of braking systems in response to the deceleration request and one or more operating parameter associated with the vehicle, and allocate the deceleration request among one or more of the plurality of braking systems based on the usage priority and braking capability of each of the plurality of braking systems.

In an embodiment, the controller is configured to allocate the deceleration request among one or more of the plurality of braking systems by assigning a pro rata share of the deceleration request to each of the plurality of braking systems.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method for braking a vehicle that includes a plurality of braking systems, the method comprising:
receiving a deceleration request for decelerating the vehicle;
determining a braking capability for each of the plurality of braking systems upon receiving the deceleration request;
allocating the deceleration request among one or more of the plurality of braking systems based on the braking capability of each of the plurality of braking systems; and
decelerating the vehicle with one or more of the plurality of braking systems in response to the allocation of the deceleration request among the plurality of braking systems.

2. The method of claim 1, further comprising:
determining a braking capability of a transmission of the vehicle;
allocating at least part of the deceleration request to the transmission based on the braking capability of the transmission; and
altering a state of the transmission in response to the allocated part of the deceleration request, wherein altering the state of the transmission includes modifying a current gear of the transmission and/or modifying a shift schedule of the transmission.

3. (canceled)

4. The method of claim 1, wherein:
the deceleration request is allocated among at least two of the plurality of braking systems and each of the at least two braking systems are applied concurrently to simultaneously satisfy the deceleration request to decelerate the vehicle in response to the allocation of the deceleration request among the plurality of braking systems.

5. (canceled)

6. The method of claim 1, further comprising communicating the braking capabilities of each of the plurality of braking systems to one or more of an adaptive cruise control system, a predictive cruise control system, a dynamic powertrain controller, and an advanced driver assistance system.

7. The method of claim 1, further comprising prioritizing usage of one or more of the plurality of braking systems over one or more other of the plurality of braking systems.

8. The method of claim 1, further comprising evaluating one or more operating parameters associated with the vehicle in order to determining the braking capability for each of the plurality of braking systems upon receiving the deceleration request, wherein the one or more operating parameters are provided by at least one of: an adaptive cruise control system, an advanced driver assistance system, an automated driving system, a dynamic powertrain control system, an anti-lock brake system, a vehicle electronic stability control system, a road condition sensor, a road grade sensor, weather data, a look ahead route data system, a LiDAR detection system, a radar detection system, a tire sensor, a vehicle-to-vehicle communication system, a platoon communication system, a traffic control system, and a transportation infrastructure communication system.

9. (canceled)

10. The method of claim 1, further comprising:
determining a deceleration capability associated with coasting the vehicle; and
prioritizing coasting the vehicle to meet the deceleration request before decelerating the vehicle with the one or more braking systems.

11. The method of claim 1, further comprising:
detecting a fault associated with one of the plurality of braking systems; and
re-allocating the deceleration request among the other of the plurality of braking systems in response to the fault and at least partially disabling the braking system for which the fault was detected.

12. (canceled)

13. The method of claim 11, further comprising altering a state of the transmission in response to detecting the fault.

14. The method of claim 11, further comprising increasing a following distance from a vehicle-in-front of the vehicle in response to detecting the fault.

15. The method of claim 11, further comprising re-prioritizing a usage priority among the plurality of braking systems in response to detecting the fault.

16. The method of claim 11, wherein the fault is a thermal event associated with a service braking system.

17. The method of claim 16, further comprising deactivating an impacted service brake of the service braking system in response to the thermal event.

18. The method of claim 1, further comprising:
determining a usage priority among the plurality of braking systems in response to the deceleration request and one or more operating parameters associated with the vehicle; and
allocating the deceleration request among one or more of the plurality of braking systems based on the usage priority and braking capability of each of the plurality of braking systems.

19. The method of claim 1, wherein allocating the deceleration request among one or more of the plurality of braking systems includes assigning a pro rata share of the deceleration request to each of the plurality of braking systems.

20. The method of claim 1, wherein the plurality of braking systems includes a service braking system and at least one of a regeneration braking system and an engine braking system.

21. The method of claim 20, wherein the plurality of braking systems further includes at least one of a resistive braking system and an aerodynamic braking system.

22. The system of claim 20, wherein the plurality of braking systems further includes a mechanical braking system, the mechanical braking system including one or more mechanical braking devices selected from: an exhaust throttle, an exhaust brake, a turbocharger, and a hydraulic retarder.

23. The method of claim 1, further comprising:
determining a braking capability of a regeneration braking system of the vehicle, wherein the braking capability of the regeneration braking system is based on one or more of torque limits for a motor/generator of the vehicle, a battery state of charge, a battery state of health, and a battery state of power; and
allocating at least part of the deceleration request to the regeneration braking transmission based on the braking capability of the regeneration braking system.

24. A vehicle, comprising:
a powertrain coupled to a drive shaft;
one or more grounding engaging wheels that are driven by the drive shaft;
a deceleration request device configured to provide a deceleration request to decelerate the vehicle;
a plurality of braking systems each configured to decelerate the vehicle;
at least one controller configured to receive the deceleration request and output one or more braking commands to the plurality of braking systems, wherein the controller is configured to:
determine a braking capability for each of the plurality of braking systems associated with the deceleration request;
allocate the deceleration request among one or more of the plurality of braking systems based on the braking capability of each of the plurality of braking systems; and
decelerate the vehicle with the one or more of the plurality of braking systems in response to the allocation of the deceleration request among the plurality of braking systems.

25-41. (canceled)
